(19) United States
(12) Patent Application Publication
(10) Pub. No.: US 2023/0239421 A1
(43) Pub. Date: Jul. 27, 2023

(54) System for Remote Production of Audiovisual Contents

(71) Applicant: BLT ITALIA S.R.L., Lido di Camaiore (LU) (IT)

(72) Inventor: Maria Teresa Cerri, Lido di Camaiore (IT)

(21) Appl. No.: 17/927,486

(22) PCT Filed: May 25, 2021
(86) PCT No.: PCT/IB2021/054527

§ 371 Date: Nov. 23, 2022

(30) Foreign Application Priority Data
May 25, 2020 (IT) 102020000012292

(51) Int. Cl. H04N 5/06; H04N 21/43

(52) U.S. Cl. CPC H04N 5/06; H04N 21/4307

(57) ABSTRACT

A system for the production of an audiovisual content includes one or more audiovisual sources adapted to generate one or more audiovisual signals at a first quality level; at least one audiovisual processing apparatus operatively connected to the audiovisual sources; at least one remote control unit operatively connected to the audiovisual processing apparatus via a data communication network; the audiovisual processing apparatus being configured for receiving the one or more audiovisual signals at a first quality level from the one or more audiovisual sources; generating at least one copy of the one or more audiovisual signals, the copy being at a second quality level; sending the copy of the one or more audiovisual signals to the remote control unit via the data communication network; receiving, via the data communication network, at least one control signal containing one or more instructions from the remote control unit; generating an audiovisual content on the basis of the one or more audiovisual signals as a function of the one or more instructions.

### BACKGROUND OF THE INVENTION

### 1. The Field of the Invention

The present invention relates to a system for the production of audiovisual contents. In particular, the present invention falls within the field of the production of audiovisual contents to be transmitted and distributed in real time for broadcasting events such as, for example, shows, sports events, political campaign debates, journalistic events, concerts, eSports (electronicSports—i.e., professional or non-professional videogame competitions), etc.

### 2. The Relevant Technology

In this frame, in order to produce and distribute an audiovisual content representative of a certain event, it is known to generate in real time a considerable number of audiovisual signals by using a plurality of sources, such as, for example, video cameras, microphones, etc. Under control of one or more operators, such audiovisual signals are usually selected and edited in real time for the purpose of generating an audiovisual signal suitable for broadcasting (i.e., suitable for real-time distribution via a telecommunications network such as, for example, a television broadcasting network).

In order to improve the representation of an event, it is known to include in the audiovisual signal being broadcast in real time some additional audiovisual contents processed starting from the same audiovisual signals acquired in real time from the sources. For example, in order to improve the comprehension of a given sequence of images during a sports event, it is often useful to transmit the repetition of some selected images or, alternatively, to propose the same sequence from a different shooting angle (i.e., acquired from an alternative source). In general, starting from the audiovisual signals acquired in real time, it is possible to produce, by executing operations like, for example, storage, editing and reproduction, a plurality of additional audiovisual contents, such as, for example, a replay, a slow motion sequence, a sequence (playlist) of video clips, video material to be subsequently edited, generation of a historical video archive, etc.

According to techniques known in the art, for producing said additional contents, the signals generated by the audiovisual sources are usually sent in real time to one or more audiovisual processing apparatuses (also referred to as audiovisual servers, video servers or audiovisual processing units in the present description) , which can execute, whether in real time or with a preset delay (merely by way of non-limiting example, due to time zone or schedule requirements), under control of one or more operators, a certain number of processing operations like, for example, cutting and editing, storage and reproduction of the received audiovisual signals.

The creation of such additional contents is thus carried out by one or more operators by means of one or more audiovisual processing apparatuses, on the basis of the signals received in real time from the audiovisual sources. Typically, such operators have at their disposal one or more monitors, which can display a certain number of audiovisual signals received in real time, and a control unit, which is operatively connected to the audiovisual server, and which can send instructions useful for creating such additional contents. Such instructions are issued by the operator as a function of the images displayed in real time on the operator's monitor; it is therefore of fundamental importance that the images displayed on the operator's monitor are as synchronized as possible with the audiovisual signals captured in real time by the sources. In other words, the latency between the acquisition of the audiovisual signal by the source and the visualization of such signal on the operator's monitor must necessarily be very low to ensure synchronism between the instructions imparted by the operator and their correct execution upon the audiovisual signals acquired in real time. If this requirement is not fulfilled, i.e., if the latency is too high, the instructions issued by the operator will be shifted in time from the images displayed on the monitor, with the consequence that the operation of selecting the sequences of images to be used for generating the additional content will be very inaccurate.

In order to keep such latency below an acceptable threshold, the stations (i.e., the monitor and the control unit) of the operators whose job is to create additional contents are typically located in proximity to the audiovisual processing apparatuses, so that it is possible to directly utilize the high-definition video outputs of the audiovisual processing apparatuses.

In turn, the audiovisual processing apparatuses are necessarily positioned in proximity to the audiovisual sources in rooms that are permanently used as a television studio or inside a mobile means of transport (also called “Outside Broadcasting Vans” or “OB Vans”). In both cases, the availability of such spaces is usually quite limited, especially for very important events; it is therefore evident that, as is often the case, the limited size of television studios is problematic whenever it is necessary to employ a large number of operators for the selection of additional contents.

### SUMMARY OF THE INVENTION

It is one object of the present invention to remedy the drawbacks of the prior art. In particular, one of the objects of the audiovisual production system of the present invention is to overcome the problem of the spatial limitations of permanent and mobile television studios. It is a further object of the present invention to keep below a predefined threshold the latency between the acquisition of the audiovisual signal and the visualization of such signal on the monitor of the operator entrusted with the production of additional contents.

### BRIEF DESCRIPTION OF THE DRAWINGS

Further objects, features and advantages of the present invention will become apparent in light of the following detailed description and the annexed drawings, which are provided merely by way of non-limiting example, wherein:

FIG. 1 schematically shows an audiovisual production system according to the prior art;

FIG. 2 schematically shows an audiovisual production system according to an embodiment of the present invention.

### DETAILED DESCRIPTION OF THE PREFERRED EMBODIMENTS

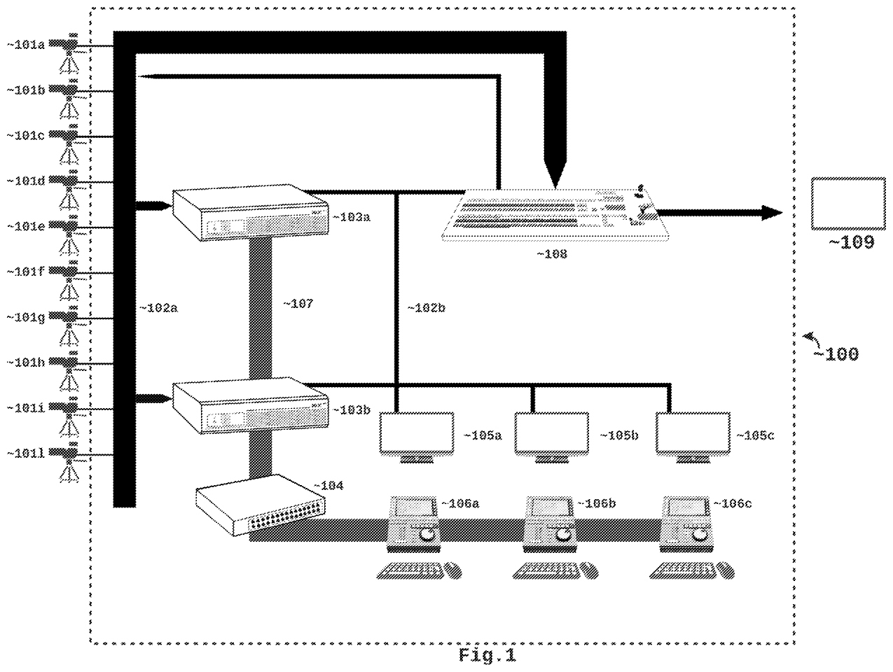

With reference to the annexed drawings, reference numeral 100 in FIG. 1 designates as a whole one example of an audiovisual production system configured in accordance with the prior art. In particular, the audiovisual production system 100 comprises a plurality of audiovisual sources 101a-101l, such as, for example, HDTV or UHDTV high-resolution video cameras, microphones, etc. Such audiovisual sources 101a-101l are operatively connected to an audiovisual mixer 108 and to a plurality of audiovisual processing apparatuses 103a and 103b via the audiovisual signal transmission system 102a. In order to minimize the delay of transmission of the audiovisual signals among the various apparatuses comprised in the audiovisual production system 100 and to avoid any degradation of the quality of the audiovisual signals acquired by the high-definition audiovisual sources 101a-101l, the audiovisual signal transmission system 102a is usually implemented in wired form, e.g., by means of coaxial or fiber-optic cables. The audiovisual signal transmission system 102a is such as to allow the transmission of the audiovisual signals generated by the audiovisual sources 101a-101l in uncompressed and non-encrypted form; for example, the transmission of the audiovisual signals via the signal transmission system 102a is usually carried out by means of an uncompressed high-resolution digital interface belonging to the “Serial Digital Interface” (SDI) standard family (other equivalent interfaces for professional use may include HDMI or uncompressed video-over-IP SMPTE 2022/2110 and later interfaces). While it is very efficient in terms of latency and signal quality protection, it is known that the signal transmission system 102a implemented by means of coaxial or fiber-optic cables is not suitable for connecting apparatuses located very distant from each other.

The audiovisual production system 100 comprises also a number of stations for the generation of additional audiovisual contents, such as, for example, replays, slow-motion sequences, etc. Each one of such stations, controlled by at least one operator, comprises at least one monitor 105a-105c and one control unit 106a-106c. Said control units 106a-106c are operatively connected to the audiovisual production apparatuses 103a-103b via a local data communication network 107, e.g., a LAN or a WLAN. The monitors 105a-105c are connected, either directly or indirectly, to one or more audiovisual signal processing apparatuses 103a-103b via an audiovisual signal transmission system 102b characterized by properties that are similar to those of the audiovisual signal transmission system 102a; in the example depicted in FIG. 1, the audiovisual signal processing apparatuses 103a-103b are configured for transmitting to the monitors 105a-105c one or more audiovisual signals, including the audiovisual signals received in real time from the audiovisual sources 101a-101l. Therefore, the monitors 105a-105c allow the control station operator to display in real time at least one audiovisual signal acquired by an audiovisual source 101a-101l; as a function of the images displayed on the monitors 105a-105c, the control station operators may directly send to the audiovisual processing apparatuses 103a-103b, in real time via the local data communication network 107, one or more control signals comprising instructions. Based on such instructions, the audiovisual processing apparatuses 103a-103b are configured for generating in real time one or more additional contents, such as, for example, replays, slow-motion sequences, etc., starting from the audiovisual signals received in real time from the audiovisual sources 101a-101b. In order to provide synchronization between the images displayed on the monitors 105a-105c and the transmission and execution of the instructions contained in the control signals, it is necessary to ensure very short latency times. In particular, it is necessary to keep the latency interval between the transmission of the control signal issued by the operator by means of one of the control units 106a-106b and the reception of such control signal by the audiovisual processing apparatuses 103a-103c within a predetermined tolerance level; this requirement is usually met because of the high speed of the local data communication network 107 and because such control signals generally contain very little information. It is also of the utmost importance to keep within a predetermined tolerance level the latency time between the acquisition of the audiovisual signals by the audiovisual sources 101a-101l and the visualization of such signals on the monitors 105a-105c; to this end, it is therefore necessary to keep within a predetermined tolerance level the latency time between the transmission of the audiovisual signals, whether or not in real time, from the audiovisual processing apparatuses 203a-203b to the monitors 105a-105c. In the example of an audiovisual content production system 100 represented in FIG. 1, the fulfilment of this requisite is ensured by the use of the high-definition signal transmission systems 102a and 102b.

The audiovisual processing apparatuses 103a-103b are also connected, via the audiovisual signal transmission system 102b, to the audiovisual mixer 108; in this manner, the audiovisual processing apparatuses 103a-b can send an output audiovisual signal comprising one or more additional contents to the audiovisual mixer 108.

Lastly, the audiovisual mixer 108 is configured for sending an audiovisual signal to a broadcasting center 109 for broadcasting the audiovisual signal.

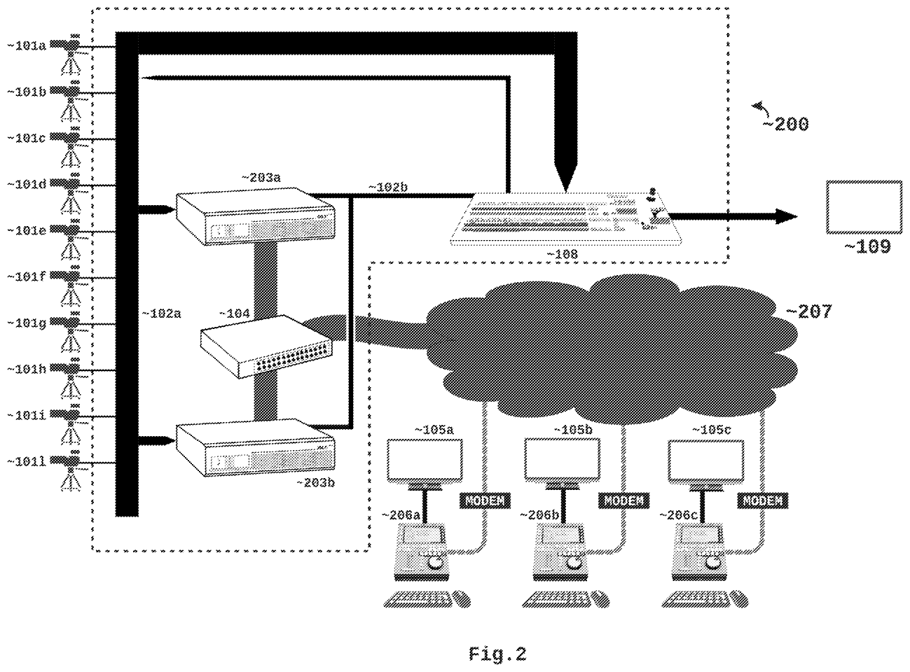

FIG. 2 shows an example of an audiovisual content production system 200 according to the present invention. All the apparatuses of the audiovisual content production system 200 individually comprise at least all of the above-described features of the apparatuses of the audiovisual content production system 100. As previously specified for the audiovisual production system 100, the audiovisual production system 200 comprises one or more audiovisual sources 101a-101l, such as, for example, HDTV or UHDTV high-resolution video cameras, microphones, etc. Said audiovisual sources (101a-101l) are configured for generating one or more audiovisual signals at a first quality level (e.g., at a quality level corresponding to high definition). The audiovisual production system 200 comprises also one or more audiovisual processing apparatuses 203a-203b operatively connected, via an audiovisual signal transmission system 102a, to said one or more audiovisual sources 101a-101l; for the reasons already indicated above, the audiovisual signal transmission system 102a ensures very short latency times, but is unsuitable for connecting apparatuses that are very distant from each other. The audiovisual processing apparatuses 203a, 203b are configured for receiving one or more audiovisual signals from the audiovisual sources via the audiovisual signal transmission system 102a.

According to one aspect of the present invention, the audiovisual production system 200 further comprises one or more remote control stations, each one comprising at least one remote control unit 206a-206c and, optionally, one or more monitors 105a-105c. Each one of said remote control units 206a-206c is operatively connected to at least one audiovisual processing apparatus 203a-203c via a data communication network 207. Said data communication network 207 may include any data communication network, preferably operating in accordance with the IP (Internet Protocol) communication protocol. For example, the data communication network 207 may be a simple LAN or WLAN local network, or may include a more extended data communication network such as a WAN network, or, more in general, may be such as to allow communication between two or more terminals connected to the Internet global data communication network.

According to a further aspect of the present invention, the audiovisual processing apparatuses 203a and 203b are also configured for generating at least one copy of said one or more input audiovisual signals at a second quality level; for example, each audiovisual processing apparatus 203a and 203b may comprise an encoder capable of encoding the input audiovisual signals at a second quality level and generating one or more data streams containing said encoded copy of the audiovisual signals. The audiovisual processing apparatuses 203a and 203b are further configured for sending in real time the data stream containing said copy of one or more audiovisual signals to the remote control units 206a-206c via the data communication network 207. Thus, by means of the remote monitors 205a-205c, in turn connected to the remote control units 206a-206c, the control station operators can display in real time the contents of the copy of the audiovisual signals sent from the audiovisual processing apparatuses 203a-203b; for example, the operators can display in real time the copy of the audiovisual signals generated by the audiovisual sources 101a-101l. Moreover, as a function of the images displayed in real time on the remote monitors 205a-205c, the operators can send to the audiovisual processing apparatuses 203a-203c, via the remote control units 206a-206c and the data communication network 207, a control signal containing one or more instructions for creating additional audiovisual contents such as, for example, replays, slow-motion sequences, etc.

As previously described, in order to provide synchronization among the control signals, the images displayed on the remote monitors 205a-205c and the execution of the instructions contained in the control signals by the audiovisual processing apparatuses 203a-203c, it is necessary to ensure very short latency times. In particular, it is necessary to keep the latency interval between the transmission of a control signal issued by the operator via one of the remote control units 206a-206b and the reception of such control signals by the audiovisual processing apparatuses 203a-203c within a predetermined tolerance level; such latency is normally negligible because of the small amount of information contained in the control signals. It is also of the utmost importance to keep within a predetermined tolerance level the latency time elapsing between the acquisition of the audiovisual signals by the audiovisual sources 101a-101l and the visualization of such signals on the remote monitors 205a-205c; according to one aspect of the present invention, such latency interval is kept under acceptable levels thanks to the encoding operations executed on the input audiovisual signals. In particular, the quality level of the copy of the audiovisual signals (i.e., the second quality level) must be such that it can be transmitted to the remote control unit 206a-206c with no perceptible delay. For this reason, said second quality level is usually lower than the first quality level of the audiovisual signals generated by the sources 101a-101l.

In order to ensure the visualization in real time (i.e., with no perceptible delay) of the audiovisual signals acquired by the audiovisual sources 101a-101l on the remote monitors 105a-105c, the audiovisual processing apparatuses 203a-203c are configured for creating a copy of such signals and sending it to the remote control units 206a-206c synchronously with the reception of such signals. In other words, the operations of encoding and sending the data stream containing the copy of the audiovisual signals are started by each one of the audiovisual processing apparatuses 203a-203b simultaneously with the arrival of the audiovisual signals from the sources 101a-101l.

The audiovisual processing apparatuses 203a-203b are also connected, via the audiovisual signal transmission system 102b, to the audiovisual mixer 108; in this manner, the audiovisual processing apparatuses 203a-b can send an output audiovisual signal comprising one or more additional contents to the audiovisual mixer 108.

Lastly, the audiovisual mixer 108 is configured for sending an audiovisual signal, also referred to as “program”, to a broadcasting center 109 for broadcasting the audiovisual signal. The audiovisual processing apparatuses 203a-203b may be further configured for generating at least one copy of said “program signal” at a second quality level and for sending said copy of the “program signal” to the remote control units 206a-206c via the data communication network 207. A third-party program signal already present in the production studio and/or in the mobile means can be made available by using the present invention.

In order to ensure further synchronism between the images displayed on the monitors 105a-105c and the instructions imparted by the operators via the control units 106a-106c, the data stream comprising the encoded copy of the audiovisual signals sent by the audiovisual processing apparatuses 203a-203c may contain additional synchronization information capable of establishing a biunivocal correspondence between one or more points of the high-resolution audiovisual signal and one or more points of the copy of the same signal. Such additional information may be useful, for example, for identifying a frame of the high-resolution audiovisual signal starting from the frame of the copy of the signal being displayed on the monitor 105a-105c. The instructions issued by the operator on the basis of one or more images displayed on the monitors 105a-105c and sent to the audiovisual processing apparatuses 203a-203b may thus comprise the synchronization information relating to said one or more images displayed on the monitors 105a-105c; in this manner, on the audiovisual processing apparatus 203a-203b it is possible to associate the instruction imparted by the operator on the remote control unit 206a-206c with the exact point(s) of the high-resolution audiovisual signal to which such instruction refers.

As regards the operators' stations, it should be reminded that they can avail themselves of the signals of the audiovisual sources 101a-101l, the main output video signal (i.e., the “program signal”), the video server's commands, and the interphone to which all operators are connected. Therefore, a third-party interphone signal (i.e., from external apparatuses) already present in the production studio and/or in the mobile means can be made available by using the present invention.

In order to ensure service continuity, the control units 206a-206c may be configured for accessing said data communication network 207 by means of a first access network and a second access network. For example, the control units 206a-206c may be interconnected over the data communication network 207 (e.g., the Internet global data network) via two or more access networks characterized by distinct access protocols such as, for example, a local WiFi network and a cellular network (e.g., LTE, LTE-a, 5G, etc.). Alternatively, the control units 206a-206c may be interconnected over the data communication network 207 (e.g., the Internet global data network) via two or more access networks of the same type, but managed by distinct operators. The remote control unit 206a-206c may therefore be configured for determining at least one first quality parameter relating to said first access network, e.g., a parameter indicative of the latency of the connection between the remote control unit 206a-206c and the audiovisual processing unit 203a-203b. Likewise, the remote control unit 206a-206c may be configured for determining at least one second parameter relating to said second access network. Access to the data communication network 207 can be gained through either the first or the second access network as a function of the values of the first quality parameter and second quality parameter. The quality parameter of each access network may be measured periodically to ensure optimal utilization of the available resources. In addition, the remote control unit 206a-206c may be configured for automatically switching from one access network to the other in the event that the access network in use cannot provide adequate network performance (i.e., when the quality parameter falls below a predefined threshold).

In addition, the control units 206a-206c may be configured for sending, via the data communication network 207, complementary audiovisual contents such as, for example, graphical text contents, images, additional audiovisual contents, etc. Such complementary audiovisual contents may be stored into a memory comprised in the remote control unit 206a-206c (e.g., an internal solid-state memory or a USB memory external to the control unit). Alternatively, the remote control units 206a-206c may be configured for retrieving, via the data communication network 207 (e.g., the Internet global communication network), complementary audiovisual contents from video servers other than the processing units 206a-206b.

It is apparent that the audiovisual content production system according to the present invention has the advantage that it allows positioning the control stations (i.e., the remote control units 206a-206c) outside rooms used as permanent television studios or OB-vans. In particular, according to one aspect of the present invention, the remote control units 206a-206c can be positioned at any distance from the audiovisual processing apparatuses 203a-203b without any geographical constraint. In this manner, the number of operators entrusted with the production of additional audiovisual contents is not limited by the little room available in television studios or OB-vans. A further advantage of the present invention lies in the fact that it keeps the latency interval of the audiovisual contents exchanged between the processing units 203a-203b and the remote control units 206a-206c below a predefined threshold.

The audiovisual production system described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described audiovisual production system, but may be subject to many modifications, improvements or replacements of equivalent parts and elements without departing from the inventive idea, as clearly specified in the following claims.

1. A system for the production of an audiovisual content, comprising:
one or more audiovisual sources adapted to generate one or more audiovisual signals at a first quality level;
at least one audiovisual processing apparatus operatively connected to said one or more audiovisual sources;
at least one remote control unit operatively connected to said audiovisual processing apparatus via a data communication network;
said audiovisual processing apparatus being configured for:
receiving said one or more audiovisual signals at a first quality level from said one or more audiovisual sources;
generating at least one copy of said one or more audiovisual signals, said copy being at a second quality level;
sending said copy of said one or more audiovisual signals to said remote control unit via said data communication network;
receiving, via said data communication network, at least one control signal containing one or more instructions from said remote control unit;
generating an audiovisual content on the basis of said one or more audiovisual signals as a function of said one or more instructions.

2. The system for the production of an audiovisual content according to claim 1, wherein said copy of said one or more audiovisual signals is generated and sent to said remote control unit synchronously with the reception of said one or more audiovisual signals.

3. The system for the production of an audiovisual content according to claim 1, wherein said audiovisual content is generated synchronously with the reception of said at least one control signal.

4. The system for the production of an audiovisual content according to claim 1, wherein said second quality level is determined as a function of a transmission delay of the data communication network.

5. The system for the production of an audiovisual content according to claim 1, wherein said audiovisual processing apparatus is configured for:
generating one or more pieces of synchronization information for the synchronization between said one or more input audiovisual signals and said at least one copy of said one or more input audiovisual signals;
sending, via said data communication network, said one or more pieces of synchronization information to said remote control unit.

6. The system for the production of an audiovisual content according to claim 5, wherein said one or more instructions comprise at least one reference to said one or more pieces of synchronization information.

7. The system for the production of an audiovisual content according to claim 1, wherein said one or more remote control units are also configured for accessing said data communication network by means of a first access network and a second access network, said one or more remote control units being further configured for:
determining at least one first quality parameter relating to said first access network;
determining at least one second quality parameter relating to said second access network;
selecting either said first access network or said second access network as a function of said first quality parameter and said second quality parameter.

8. An audiovisual processing apparatus comprising:
one or more inputs configured for receiving one or more audiovisual signals at a first quality level;
a communication module operatively connected to a data communications network;
an encoder configured for generating at least one copy at a second quality level of said one or more audiovisual signals; and
a processing unit configured for:
sending, via said communication module, said copy of said one or more audiovisual signals to a remote control unit;
receiving at least one control signal containing one or more instructions from said remote control unit via said data communication network; and
generating an audiovisual content starting from said one or more audiovisual signals at a first quality level as a function of said one or more instructions.

9. A remote control unit comprising:
a user interface configured for receiving one or more instructions;
a communication module operatively connected to a data communications network; and
a processing unit configured for:
receiving, via said data communication network, a copy at a second quality level of one or more audiovisual signals at a first quality level, said copy at a second quality level being sent from an audiovisual processing apparatus;
receiving one or more instructions through said user interface;
generating a control signal containing said one or more instructions; and
sending said control signal to said audiovisual processing apparatus via said data communication network.
